(19) United States
(12) Patent Application Publication
(10) Pub. No.: US 2020/0282617 A1
(43) Pub. Date: Sep. 10, 2020

(54) MANAGEMENT SYSTEM FOR INJECTION MOLDING MACHINE AND CENTRALIZED MANAGEMENT SYSTEM FOR INJECTION MOLDING MACHINES

(71) Applicant: FANUC CORPORATION, Yamanashi (JP)

(72) Inventors: Masaya TAJIKA, Yamanashi (JP); Junpei MARUYAMA, Yamanashi (JP)

(21) Appl. No.: 16/784,702

(22) Filed: Feb. 7, 2020

(30) Foreign Application Priority Data
Mar. 6, 2019 (JP) 2019-040497

(51) Int. Cl. B29C 45/84; B29C 45/76; B29C 45/78

(52) U.S. Cl. CPC B29C 45/84; B29C 45/768; B29C 45/7653; B29C 2945/76016; B29C 2945/7604; B29C 2945/76481; B29C 45/78

(57) ABSTRACT

The management system has an injection molding machine and a management unit for managing the injection molding machine, wherein the management unit includes: a plurality of physical quantity measurement units configured to be provided at a plurality of movable parts included in the injection molding machine; an ascertainment unit configured to calculate, based on a plurality of physical quantity data respectively measured by the plurality of physical quantity measurement units, a comparative relationship representing a relational state of the plurality of physical quantity data between the plurality of the movable parts, and to ascertain whether the comparative relationship deviates from a preset reference comparative relationship; and an alarm unit configured to issue an alarm when the ascertainment unit ascertains that the comparative relationship deviates from the reference comparative relationship.

This application is based on and claims the benefit of priority from Japanese Patent Application No. 2019-040497, filed on 6 Mar. 2019, the content of which is incorporated herein by reference.

### BACKGROUND OF THE INVENTION

### Field of the Invention

The present disclosure relates to a management system for injection molding machine and a centralized management system for injection molding machines.

### Related Art

Generally, an injection molding machine includes a mold unit composed of a fixed mold and a movable mold, a mold clamping mechanism unit for clamping the fixed mold and the movable mold, and an injection mechanism unit for injecting a molding material into a cavity between the fixed mold and the movable mold. Since such an injection molding machine has many movable parts, the movable parts are greased with an appropriate timing in order to prevent wear of the movable parts. For example, in the case of a mold clamping mechanism unit of a toggle type having a plurality of links, since the links frequently rotate to open and close the molds, connecting parts (bushes) between the links are susceptible to wear. Therefore, it is necessary to grease the connecting parts with an appropriate timing.

A technique has been developed focusing on a correlation between a friction coefficient and a temperature. According to this known technique, greasing timing is determined from an increase in temperature of a movable part of an injection molding machine (e.g., see Patent Documents 1 and 2).

Patent Document 1: Japanese Patent No. 2851940

Patent Document 2: Japanese Patent No. 3410348

### SUMMARY OF THE INVENTION

An increase in temperature of a movable part is not always caused by mere lack of grease, but may be caused by abnormal wear in the movable part. In the case where abnormal wear has occurred in a movable part, the movable part needs to be replaced as soon as possible. Therefore, if an increase in temperature of a movable part is detected, the injection molding machine is determined to be in an abnormal state, so that some measures against the abnormal state, such as greasing and part replacement, can be prepared.

However, the temperature of a movable part of an injection molding machine may be raised not only by lack of grease or abnormal wear, but also by a change in the external environment where the injection molding machine is placed or high load conditions of molding parameters. In the case of the latter, the injection molding machine may be mistakenly determined to be in an abnormal state, contrary to its actual state. Therefore, in the field of injection molding machines, there has been a demand for a technique of accurately ascertaining an abnormal state of a movable part.

An aspect of a management system for injection molding machine of the present disclosure is a management system having an injection molding machine and a management unit for managing the injection molding machine. The management unit includes: a plurality of physical quantity measurement units configured to be provided at a plurality of movable parts included in the injection molding machine; an ascertainment unit configured to calculate, based on a plurality of physical quantity data respectively measured by the plurality of physical quantity measurement units, a comparative relationship representing a relational state of the plurality of physical quantity data between the plurality of the movable parts, and to ascertain whether the comparative relationship deviates from a preset reference comparative relationship; and an alarm unit configured to issue an alarm when the ascertainment unit ascertains that the comparative relationship deviates from the reference comparative relationship.

An aspect of a centralized management system for injection molding machines of the present disclosure is a centralized management system having a plurality of injection molding machines and a centralized management unit for managing the plurality of injection molding machines in a centralized manner. The centralized management unit includes: a plurality of physical quantity measurement units configured to be provided at a plurality of movable parts included in each of the plurality of injection molding machines; an ascertainment unit configured to ascertain whether any of the plurality of injection molding machines is in an abnormal state, based on a plurality of physical quantity data respectively measured by the plurality of physical quantity measurement units; and an alarm unit configured to issue an alarm. The ascertainment unit has: a first function of calculating a plurality of first comparative relationships each representing a relational state of the plurality of physical quantity data between the movable parts included in an associated one of the injection molding machines, based on the plurality of physical quantity data respectively measured by the plurality of physical quantity measurement units, and of ascertaining whether there is a deviation of any of the first comparative relationships from a preset first reference comparative relationship; and a second function of calculating a plurality of second comparative relationships each representing a relational state between the plurality of first comparative relationships of the plurality of injection molding machines, and of ascertaining whether there is a deviation of any of the second comparative relationships from a preset second reference comparative relationship, the second function being carried out when presence of the deviation is ascertained by the first function. The alarm unit issues an alarm when presence of the deviation is ascertained by the second function.

An aspect of the management system for injection molding machine can accurately ascertain an abnormal state of a movable part of an injection molding machine. An aspect of the centralized management system for injection molding machines can accurately ascertain an abnormal state of a movable part of each of a plurality of injection molding machines.

### BRIEF DESCRIPTION OF THE DRAWINGS

FIG. 1 shows an overview of an embodiment of a management system for injection molding machine;

FIG. 2 is a block diagram showing an embodiment of a management unit of the management system for injection molding machine shown in FIG. 1;

FIG. 3 is a flowchart showing an example of control performed by the management system for injection molding machine shown in FIG. 1;

FIG. 4 is a block diagram showing an overview of an embodiment of a centralized management system for injection molding machines;

FIG. 5 is a block diagram showing an update unit;

FIG. 6A is a flowchart showing an example of control performed by the centralized management system for injection molding machines shown in FIG. 4; and

FIG. 6B is a flowchart showing the example of control performed by the centralized management system for injection molding machines shown in FIG. 4.

### DETAILED DESCRIPTION OF THE INVENTION

### [Management System for Injection Molding Machine]

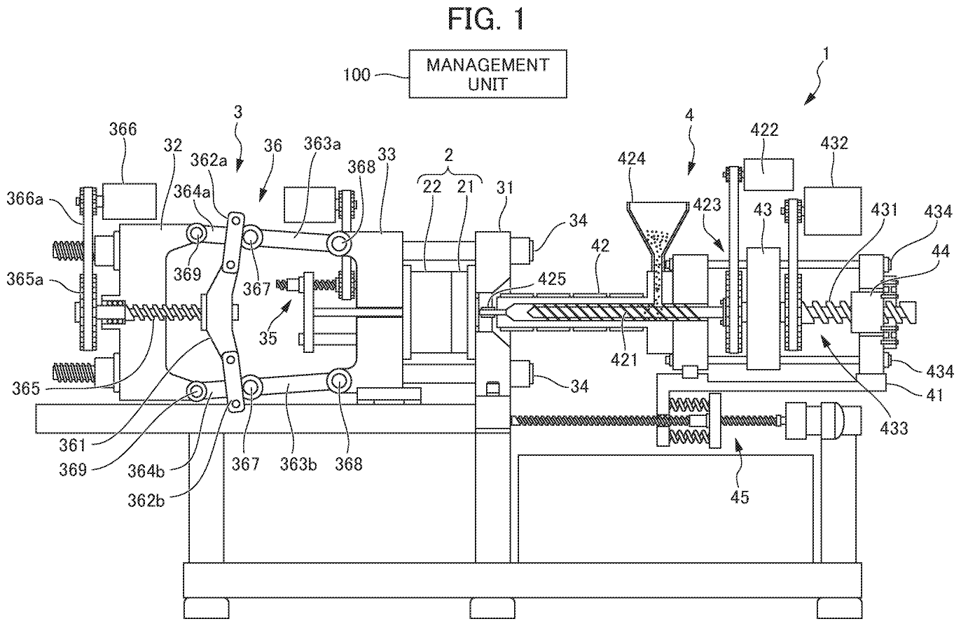

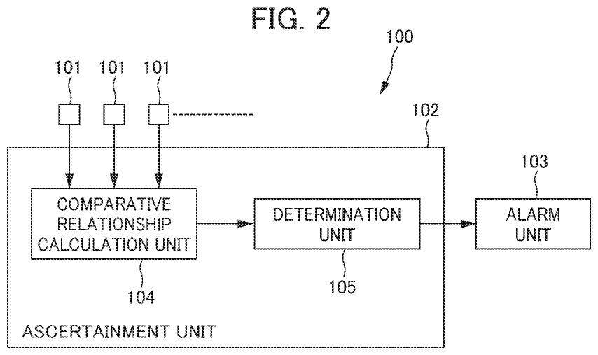

An embodiment of a management system for injection molding machine will be described in detail with reference to the drawings. FIG. 1 shows an overview of the embodiment of the management system for injection molding machine. FIG. 2 is a block diagram showing an embodiment of a management unit. As shown in FIG. 1, the management system for injection molding machine includes an injection molding machine 1, a management unit 100 for managing the injection molding machine 1.

The injection molding machine 1 includes: a mold unit 2 composed of a fixed mold 21 and a movable mold 22; a mold clamping mechanism unit 3 for clamping the fixed mold 21 and the movable mold 22; and an injection mechanism unit 4 for injecting a molding material into a cavity (not shown) between the fixed mold 21 and the movable mold 22.

The mold clamping mechanism unit 3 is of a toggle type. In the mold clamping mechanism unit 3, a fixed platen 31 and a rear platen 32 are connected to each other via a plurality of die bars 34. A movable platen 33 is disposed between the fixed platen 31 and the rear platen 32. The movable platen 33 is movable along the die bars 34, and is configured to move forward and backward with respect to the fixed platen 31. The fixed mold 21 is mounted to the fixed platen 31. The movable mold 22 is mounted to the movable platen 33. The movable platen 33 is provided with an ejector device 35 for pushing and ejecting a molding from the movable mold 22.

A toggle mechanism 36 for moving the movable platen 33 forward and backward is provided between the rear platen 32 and the movable platen 33. The toggle mechanism 36 is composed of a crosshead 361, upper crosshead links 362a, lower crosshead links 362b, upper front toggle links 363a, lower front toggle links 363b, upper rear toggle links 364a, and lower rear toggle links 364b. Note that in the mold clamping mechanism unit 3, the toggle mechanism 36 is provided symmetrically (with respect to a direction perpendicular to the paper plane of FIG. 1). Therefore, each part and its counterpart part form a pair in the mold clamping mechanism unit 3.

The crosshead 361 is screwed on a ball screw 365 that is attached to the rear platen 32 such that the ball screw 365 is rotatable but immovable in an axial direction (in the lateral direction in FIG. 1). A pulley 365a is attached to the ball screw 365, so that driving force is transmitted from a mold clamping motor 366 via a belt 366a wrapped around an output shaft of the mold clamping motor 366. The crosshead 361 moves forward and backward in the axial direction of the ball screw 365 when the ball screw 365 is rotated.

The lower end of the upper crosshead link 362a is coupled, via a shaft, to the upper end of the crosshead 361, so that the upper crosshead link 362a is pivotable. The upper end of the lower crosshead link 362b is coupled, via a shaft, to the lower end of the crosshead 361, so that the lower crosshead link 362b is pivotable. The upper end of the upper crosshead link 362a is coupled, via a shaft, to the upper rear toggle link 364a, so that the upper crosshead link 362a is pivotable. The lower end of the lower crosshead link 362b is coupled, via a shaft, to the lower rear toggle link 364b, so that the lower crosshead link 362b is pivotable.

The upper front toggle link 363a, the lower front toggle link 363b, the upper rear toggle link 364a and the lower rear toggle link 364b are arranged to extend between the rear platen 32 and the movable platen 33. The rear end of the upper front toggle link 363a and the front end of the upper rear toggle link 364a are pivotably coupled to each other via a central bush 367. The rear end of the lower front toggle link 363b and the front end of the lower rear toggle link 364b are pivotably coupled to each other via another central bush 367. The front end of the upper front toggle link 363a is pivotably coupled to the movable platen 33 via a front bush 368. The front end of the lower front toggle link 363b is pivotably coupled to the movable platen 33 via another front bush 368. The rear end of the upper rear toggle link 364a is pivotably coupled to the rear platen 32 via a rear bush 369. The rear end of the lower rear toggle link 364b is pivotably coupled to the rear platen 32 via another rear bush 369.

The upper end of the upper crosshead link 362a is coupled, via a shaft, to the upper rear toggle link 364a between the central bush 367 and the rear bush 369, so that the upper crosshead link 362a is pivotable. The lower end of the lower crosshead link 362b is coupled, via a shaft, to the lower rear toggle link 364b between the central bush 367 and the rear bush 369, so that the lower crosshead link 362b is pivotable.

Thus, when the crosshead 361 moves forward in the axial direction of the ball screw 365 (in the rightward direction in FIG. 1), the upper rear toggle link 364a and the lower rear toggle link 364b are pushed by the upper crosshead link 362a and the lower crosshead link 362b, and accordingly, are pivoted upward and downward respectively about the rear bushes 369. Consequently, the upper rear toggle link 364a and the lower rear toggle link 364b become substantially in line with the upper front toggle link 363a and the lower front toggle link 363b, respectively. As a result, the movable platen 33 moves forward toward the fixed platen 31, so that the mold unit 2 is clamped as shown in FIG. 1.

On the other hand, when the crosshead 361 moves backward in the axial direction of the ball screw 365 (in the leftward direction in FIG. 1), the upper rear toggle link 364a and the lower rear toggle link 364b are pulled by the upper crosshead link 362a and the lower crosshead link 362b, and accordingly, are pivoted downward and upward respectively about the rear bushes 369. Consequently, the upper front toggle link 363a and the upper rear toggle link 364a form an inward bend at the associated central bush 367, while the lower front toggle link 363b and the lower rear toggle link 364b form an inward bend at the associated central bush 367. As a result, the movable platen 33 moves backward away from the fixed platen 31, so that the mold unit 2 is opened.

The injection mechanism unit 4 includes a base 41 and an injection cylinder 42 that is placed on an end of the base 41, the end being close to the mold clamping mechanism unit 3. The injection cylinder 42 has an injection screw 421 inserted therein. The injection screw 421 is rotated by an injection screw-rotating motor 422 via a transmission mechanism 423 composed of a pulley, a belt, etc. The injection cylinder 42 is mounted with a hopper 424 for supplying a molding material into the injection cylinder 42.

An end of the injection screw 421 is rotatably mounted to an injection ball screw housing 43. The injection ball screw housing 43 is provided with an injection ball screw 431 that is rotatable and projects away from the injection screw 421. The injection ball screw 431 is screwed into a nut part 44 provided at an end of the base 41, the end being far from the mold clamping mechanism unit 3. The injection ball screw 431 is rotated by an injection motor 432 via a transmission means 433 composed of a pulley, a belt, etc. Thus, the injection ball screw 431 causes the injection ball screw housing 43 to slide along an injection shaft guide 434. The sliding movement of the injection ball screw housing 43 causes the injection screw 421 to move linearly inside the injection cylinder 42 toward the mold clamping mechanism unit 3. The structure for implementing the sliding movement of the injection ball screw housing 43 may be a biaxial structure in which the injection ball screws 431 having the same structure are arranged parallelly with each other.

A nozzle touch mechanism 45 is arranged below the base 41. The nozzle touch mechanism 45 moves the base 41 toward and away from the mold clamping mechanism unit 3 such that a nozzle 425 of the injection cylinder 42 comes into contact with, or is spaced apart from, the fixed platen 31.

In the thus configured injection molding machine 1, for example, the links constituting the toggle mechanism 36 of the mold clamping mechanism unit 3 are movable parts that are frequently pivoted to open and close the mold unit 2. In addition, a screwed portion between the injection ball screw 431 and the nut part 44 of the injection mechanism unit 4 is also another movable part. The movable parts included in the injection molding machine 1 are each a part for which it is desirable to monitor an abnormal state, such as lack of grease, abnormal wear, strain and vibration.

As shown in FIG. 2, the management unit 100 includes physical quantity measurement units 101, an ascertainment unit 102 and an alarm unit 103. Although FIG. 1 shows that the management unit 100 is arranged in the vicinity of the injection molding machine 1, the position of the management unit 100 is not particularly limited. The management unit 100 may be provided in a control device (not shown) for controlling the motion of the injection molding machine 1.

Although not shown in FIG. 1, the physical quantity measurement units 101 are attached to measurement points on the injection molding machine 1, so that the physical quantity measurement units 101 each measure a physical quantity at the associated measurement point. The physical quantity measurement units 101 are appropriately implemented as specific components in accordance with a physical quantity to be measured. For example, a temperature sensor is used in a case where a temperature is measured as a physical quantity. A strain sensor is used in a case where an amount of strain is measured as a physical quantity. Further, a vibration sensor is used in a case where an amount of vibration is measured as a physical quantity.

The management unit 100 has the plurality of physical quantity measurement units 101. The plurality of physical quantity measurement units 101 are attached to the above-described plurality of movable parts included in the injection molding machine 1, while the movable parts are set as the measurement points. Each physical quantity measurement unit 101 may be attached directly to the movable part or to a location in the vicinity of the movable part, as long as the physical quantity measurement unit 101 can measure the physical quantity of the movable part. Data of the physical quantity measured by each physical quantity measurement unit 101 is input to the ascertainment unit 102.

The ascertainment unit 102 of the present embodiment ascertains, based on the plurality of physical quantity data respectively measured by the plurality of physical quantity measurement units 101, whether a comparative relationship of the physical quantity data between the plurality of movable parts deviates from a preset relationship state. The ascertainment unit 102 includes a comparative relationship calculation unit 104 and a determination unit 105.

The comparative relationship calculation unit 104 calculates the comparative relationship representing a relational state of the physical quantity data between the movable parts, from the plurality of physical quantity data inputted by the plurality of physical quantity measurement units 101. The “comparative relationship” as used herein refers to a relationship in terms of magnitude, such as large or small and high or low, between the physical quantity data. The comparative relationship of the physical quantity data represents a balance between the states (temperature, strain, vibration, etc.) of the plurality of movable parts subjected to the measurement of the physical quantity. For example, supposing that when the movable parts are all in a normal state, the temperatures thereof as the physical quantity are all the same. In this case, the comparative relationship of the physical quantity data represents a state in which all the movable parts are at the same temperature. The comparative relationship represents not absolute values of the physical quantity data of the movable parts, but a balance between the physical quantity data. Therefore, for example, even if all the movable parts increase in temperature due to a rise in temperature caused by a change in the external environment or a change in molding conditions, the balance between the states represented by the comparative relationship is not disrupted. On the other hand, when any one of the plurality of movable parts increases in temperature due to occurrence of an abnormal state such as lack of grease or abnormal wear, an increase occurs in only the physical quantity data of the movable part experiencing the abnormal state, resulting in that the comparative relationship of the physical quantity data indicates a balance that is disrupted as compared with the normal state where the movable parts are all at the same temperature.

This comparative relationship of the physical quantity data can be calculated, for example, in the following manner. In a case where the injection mechanism unit 4 has a biaxial structure in which the injection ball screws 431 are parallelly arranged, first, a temperature of a greasing part of each of the injection ball screws is measured (here, one of the injection ball screws is denoted by 431A and the other is denoted by 431B). If the one injection ball screw 431A has a temperature of 40° C. and the other injection ball screw 431B has a temperature of 42° C. when the machine is in operation, the comparative relationship is described as “42−40=2”. Data of the calculated comparative relationship is outputted to the determination unit 105.

The determination unit 105 compares the data of the comparative relationship inputted from the comparative relationship calculation unit 104 with data of a preset reference comparative relationship, and determines whether the comparative relationship calculated by the comparative relationship calculation unit 104 deviates from the reference comparative relationship. The “reference comparative relationship” represents an ideal comparative relationship of the physical quantity data between the plurality of movable parts subjected to the measurement of the physical quantity, the ideal comparative relationship being observed when the movable parts are in a normal state. The data of the reference comparative relationship is stored as a preset value in an ascertainment unit 102. When determining that the comparative relationship deviates from the reference comparative relationship as a result of the comparison between the data of the comparative relationship and the data of reference comparative relationship, the determination unit 105 outputs a signal indicating the deviation to the alarm unit 103.

The determination on whether the comparative relationship deviates from the reference comparative relationship can be made, for example, by determining whether a difference between the data of the comparative relationship and the data of the reference comparative relationship is within a predetermined threshold range. For example, if temperatures are measured as the physical quantity, a situation where a calculated difference between the comparative relationship and the reference comparative relationship is “0” (a situation where the temperatures are equal to each other) is defined as a reference, and a range is set while a predetermined threshold such as a measurement error of, e.g., “±5” (±5° C.) is taken into account. The determination on whether the comparative relationship deviates from the reference comparative relationship can be made by determining whether the difference is within the range.

When determining that the calculated comparative relationship deviates from the reference comparative relationship, the determination unit 105 can identify, among the plurality of movable parts, one movable part that is in an abnormal state and has caused the disruption of the balance, based on the data of the comparative relationship calculated by the comparative relationship calculation unit 104. For instance, in the example of the above comparative relationship, there is a possibility that the movable part having the higher temperature is in an abnormal state such as abnormal wear. Alternatively, in a case where the comparative relationship is monitored at measurement points of, for example, three movable parts A, B and C, the measurement points are combined in three ways, namely A-B, B-C and C-A, for calculation of the comparative relationship. If the comparative relationship between the measurement points B and C is solely normal among the three combinations, a determination can be made that the movable part corresponding to the measurement point A causes disruption of balance, i.e., is in an abnormal state. Information about the identified abnormal movable part is outputted to the alarm unit 103.

If the presence of an abnormal state is ascertained by the ascertainment unit 102, the alarm unit 103 alerts an operator that the injection molding machine 1 is in an abnormal state. At the same time, the information about the abnormal movable part outputted from the ascertainment unit 102 can be provided to the operator. Specific examples of the alerting means include display on a liquid crystal monitor or the like, and a voice notification.

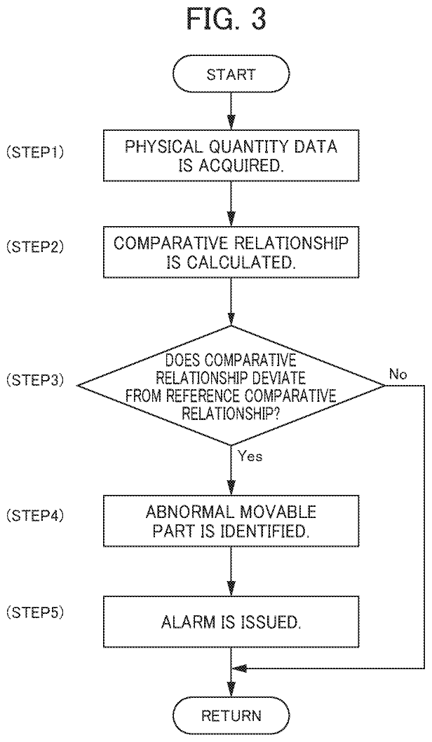

Next, specific control performed by the management system for injection molding machine of the present embodiment will be described with reference to FIG. 3. FIG. 3 is a flowchart showing an example of control performed by the management system for injection molding machine. The plurality of physical quantity measurement units 101 acquire, repeatedly in a predetermined control cycle, a plurality of physical quantity data from a plurality of movable parts, during operation of the injection molding machine 1. When the predetermined control cycle starts, the management unit 100 acquires physical quantity data from each of the physical quantity measurement units 101 respectively provided at the plurality of movable parts of the injection molding machine 1 (STEP 1).

Next, the comparative relationship calculation unit 104 of the ascertainment unit 102 calculates a comparative relationship from the plurality of physical quantity data that have been acquired. Data of the calculated comparative relationship is outputted to the determination unit 105 (STEP 2). The determination unit 105 compares the data of the comparative relationship calculated by the comparative relationship calculation unit 104 with the data of a preset reference comparative relationship, and then, determines whether the comparative relationship deviates from the reference comparative relationship (STEP 3).

When the determination unit 105 determines that the comparative relationship does not deviate from the reference comparative relationship as a result of the comparison (if the answer is No in STEP 3), the process returns to STEP 1, from which the processing is repeated upon starting of the next control cycle. On the other hand, when determining that the comparative relationship deviates from the reference comparative relationship as a result of the comparison (if the answer is Yes in STEP 3), the determination unit 105 identifies an abnormal movable part that has caused disruption of balance among the plurality of movable parts, based on the data of the comparative relationship calculated by the comparative relationship calculation unit 104 (STEP 4).

After the determination unit 105 has identified the abnormal movable part, the ascertainment unit 102 outputs a signal to the alarm unit 103, together with information about the abnormal movable part. In response to this, the alarm unit 103 issues an alarm indicating presence of the abnormal movable part in the injection molding machine 1 so as to alert the operator to the abnormality in the injection molding machine 1, and provides the operator with the information about the abnormal movable part (STEP 5).

The issuance of the alarm allows the operator to check the state of the abnormal movable part of the injection molding machine 1. If the operator determines that the state of the abnormal movable part has been caused by simple lack of grease, the operator greases the movable part. After the issuance of the alarm, the process returns. However, if the operator determines that the abnormal movable part is not in an abnormal state of simple lack of grease, but in an abnormal state such as abnormal wear, the operator stops the operation of the injection molding machine 1 so that part replacement or the like can be carried out. The management unit 100 may automatically stop the operation of the injection molding machine 1, at the same time as the issuance of the alarm.

Specific examples of detection of an abnormal state of the movable parts of the injection molding machine 1 will be described below.

### Specific Example 1

Unit to be measured: Mold clamping mechanism unit 3

Physical quantity measurement units: Temperature sensors

Physical quantity to be measured: Temperature

Measurement points (movable parts): Greasing points at the link connecting parts in the toggle mechanism 36

Measurement points A: The right- and left-upper crosshead links 362a and the right- and left-lower crosshead links 362b (four locations in total)
Measurement Points B: The upper-right, upper-left, lower-right and lower-left front bushes 368 (four locations in total)
Measurement points C: The upper-right, upper-left, lower-right and lower-left central bushes 367 (four locations in total)
Measurement points D: The upper-right, upper-left, lower-right and lower-left rear bushes 369 (four locations in total)

Definition of the comparative relationship of the measurement points in a normal state

The four movable parts as the measurement points A all exhibit the same temperature in the normal state.
The four movable parts as the measurement points B all exhibit the same temperature in the normal state.
The four movable parts as the measurement points C all exhibit the same temperature in the normal state.
The four movable parts as the measurement points D all exhibit the same temperature in the normal state.

While the link connecting parts serving as the measurement points are moving normally, all of the measurement points A to D maintain a comparative relationship described as the same temperature. In this case, an increase in the temperature of the injection molding machine 1 due to a change in the external environment or high-load molding causes a rise in the temperature of each of the link connecting parts. However, since the rise in the temperature is uniform among all the link connecting parts, the comparative relationship described as the same temperature exhibited by all the measurement points A to D remains unchanged. Therefore, even if a temperature change occurs due to the external environment or high-load molding, there is substantially no possibility that the management unit 100 determines that an abnormal state is present.

On the other hand, if the temperature of any of the link connecting parts increases significantly, the comparative relationship between the measurement points A to D exceeds a predetermined threshold and deviates from a preset reference comparative relationship. In this case, the management unit 100 ascertains that an abnormal state such as a greasing error or abnormal wear has occurred, and alerts the operator to the abnormal state through the alarm unit 103 while providing information about the abnormal movable part identified by the determination unit 105. Note that the comparative relationship between the measurement points B, C and D may be theoretically calculated from a difference in load, speed, stroke, etc. of the measurement points.

### Specific Example 2

Measurement unit: Injection mechanism unit 4 of a biaxial type

Physical quantity measurement units: Temperature sensors

Physical quantity to be measured: Temperature

Measuring points (movable parts): Greasing points located at the screwed portions between the injection ball screws 431 and the nut parts 44 of the injection cylinder 42 of the biaxial type.

Definition of the comparative relationship of the measurement points in a normal state

In the injection cylinder 42 of the biaxial type, the two injection ball screws 431 are the same in specification, and exhibit same temperature.

While the measurement points, i.e., the screwed portions between the injection ball screws 431 and the associated nut parts 44 are operating normally, the screwed portions maintain a comparative relationship described as the same temperature. In this case, an increase in the temperature of the injection molding machine 1 due to a change in the external environment or high-load molding causes a rise in the temperature of each of the screwed portions. However, since the rise in the temperature is uniform between the screwed portions, the comparative relationship described as the same temperature exhibited by the screwed portions remains unchanged. Therefore, even if a temperature change occurs due to the external environment or high-load molding, there is substantially no possibility that the management unit 100 determines that an abnormal state is present.

On the other hand, if the temperature of either one of the screwed portions increases significantly, the comparative relationship between the screwed portions exceeds a predetermined threshold and deviates from a preset reference comparative relationship. In this case, the management unit 100 ascertains that an abnormal state such as a greasing error or abnormal wear has occurred, and alerts the operator to the abnormal state through the alarm unit 103 while providing information about the abnormal movable part identified by the determination unit 105.

### Specific Example 3

Unit to be measured: Mold clamping mechanism unit 3

Physical quantity measurement units: Strain sensors

Physical quantity to be measured: Strain

Measurement points (movable parts): Central portions of the links (link central portions) included in the toggle mechanism 36

Measurement points E: The right- and left-upper front toggle links 363a (two locations in total)
Measurement points F: The right- and left-lower front toggle links 363b (two locations in total)
Measurement points G: The right- and left-upper rear toggle links 364a (two locations in total)
Measurement points H: The right- and left-lower rear toggle links 364b (two locations in total)

Definition of the comparative relationship of the measurement points in a normal state

The two movable parts as the measurement points E both exhibit the same amount of strain in the normal state.
The two movable parts as the measurement points F both exhibit the same amount of strain in the normal state.
The two movable parts as the measurement points G both exhibit the same amount of strain in the normal state.
The two movable parts as the measurement points H both exhibit the same amount of strain in the normal state.

While the link central portions serving as the measurement points are moving normally, all of the link central portions maintain a comparative relationship described as the same amount of strain. In this case, an increase in the temperature of the injection molding machine 1 due to a change in the external environment or high-load molding causes a change in the amount of strain of each of the link central portions. However, since the change in the amount of strain is uniform among the link central portions, the comparative relationship described as the same amount of strain exhibited by all the link central portions remains unchanged. Therefore, even if a temperature change due to the external environment or high-load molding causes a change in the amounts of strain, there is substantially no possibility that the management unit 100 determines that an abnormal state is present.

On the other hand, if the amount of strain of any of the link central portions increases significantly, the comparative relationship between the link central portions exceeds a predetermined threshold and deviates a preset reference comparative relationship. In this case, the management unit 100 ascertains that an abnormal state such as a greasing error or abnormal wear has occurred, and alerts the operator to the abnormal state through the alarm unit 103 while providing information about the abnormal movable part identified by the determination unit 105.

When a comparison is made between an upper portion and a lower portion of the toggle mechanism 36 (between the upper front toggle link 363a and the lower front toggle link 363b, and between the upper rear toggle link 364a and the lower rear toggle link 364b), a force in the direction of gravity acts in opposite directions in the upper and lower portions, with respect to the same shape of the upper and lower links. This fact may be taken into account when the comparative relationship of the amount of strain is calculated for setting the reference comparative relationship. In addition to the above, the comparative relationship between the measurement points E, F, G and H may be theoretically calculated from the difference in load, speed, stroke etc. of the measurement points.

### Specific Example 4

Unit to be measured: Mold clamping mechanism unit 3

Physical quantity measurement units: Vibration sensors

Physical quantity to be measured: Vibration

Measurement points (movable parts): Central portions of the links (link central portions) included in the toggle mechanism 36

Measurement points E: The right- and left-upper front toggle links 363a (two locations in total)
Measurement points F: The right- and left-lower front toggle links 363b (two locations in total)
Measurement points G: The right- and left-upper rear toggle links 364a (two locations in total)
Measurement points H: The right- and left-lower rear toggle links 364b (two locations in total)

Definition of the comparative relationship of the measurement points in a normal state

The two movable parts as the measurement points E both exhibit the same amount of vibration in the normal state.
The two movable parts as the measurement points F both exhibit the same amount of vibration in the normal state.
The two movable parts as the measurement points G both exhibit the same amount of vibration in the normal state.
The two movable parts as the measurement points H both exhibit the same amount of vibration in the normal state.

While the link central portions serving as the measurement points are moving normally, all of the link central portions maintain a comparative relationship described as the same amount of vibration. In this case, a change occurs in the amount of vibration of each of the link central portions, depending on the molding condition of the injection molding machine 1. However, since the change in the amount of vibration is uniform among the link central portions, the comparative relationship described as the same amount of vibration exhibited by all the link central portions remains unchanged. Therefore, even if a change in the molding conditions causes a change in the amounts of vibration, there is substantially no possibility that the management unit 100 determines that an abnormal state is present.

On the other hand, if the amount of vibration of any of the link central portions increases, the comparative relationship between the link central portions exceeds a predetermined threshold and deviates from a preset reference comparative relationship. In this case, the management unit 100 ascertains that an abnormal state such as a greasing error or abnormal wear has occurred, and alerts the operator to the abnormal state through the alarm unit 103 while providing information about the abnormal movable part identified by the determination unit 105.

As described above, the management system for injection molding machine of the present embodiment, which ascertains whether the comparative relationship of the physical quantity data between the plurality of movable parts of the injection molding machine 1 deviates from the preset reference comparative relationship, can accurately ascertain an abnormal state of the movable parts of the injection molding machine 1, without being affected by a change in the external environmental, a change in the molding conditions, etc.

### [Centralized Management System for Injection Molding Machines]

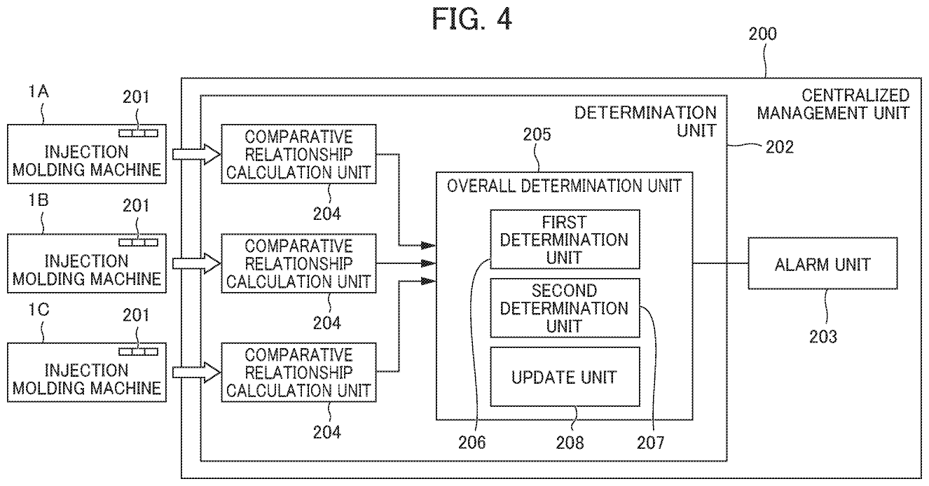

Next, an embodiment of a centralized management system for injection molding machines will be described in detail with reference to FIG. 4. FIG. 4 is a block diagram showing the embodiment of the centralized management system for injection molding machines. The centralized management system for injection molding machines of the present embodiment is for use in a molding process using a plurality of injection molding machines 1 shown in FIG. 1, and is configured to ascertain an abnormal state in each of the injection molding machines 1.

As shown in FIG. 4, the centralized management system for injection molding machines according to the present embodiment includes the plurality of injection molding machines 1A, 1B, and 1C, a single centralized management unit 200 for collectively managing the plurality of injection molding machines 1A, 1B, and 1C. The injection molding machines 1A, 1B and 1C each have the same configuration as that of the injection molding machine 1 shown in FIG. 1. The detailed description provided above applies to the injection molding machines of the present embodiment, and is not repeated in the description of the present embodiment. Note that the three injection molding machines 1A, 1B and 1C of the present embodiment are of the same type and perform the same molding process. In the present embodiment, however, the number of the injection molding machines 1 is not limited to three, but may be any number equal to or greater than two.

The centralized management unit 200 includes physical quantity measurement units 201, an ascertainment unit 202 and an alarm unit 203. Like the management unit 100 of the above-described management system for injection molding machine, the position of the centralized management unit 200 shown in FIG. 4 is not particularly limited.

The physical quantity measurement unit 201 is the same as the physical quantity measurement unit 101 of the above-described management system for injection molding machine. Two or more physical quantity measurement units 201 are provided at each of the injection molding machines 1A, 1B and 1C, in correspondence with two or more movable parts of the injection molding machine. In FIG. 4, hollow arrows schematically indicate physical quantity data that is measured by the physical quantity measurement units 201 provided at the injection molding machines 1A, 1B and 1C, and that is inputted to the ascertainment unit 202. Thus, as in the above-described management system for injection molding machine, physical quantity data inputted from the injection molding machines 1A, 1B and 1C to the ascertainment unit 202 includes a plurality of physical quantity data measured by the plurality of physical quantity measurement units 201 provided at the injection molding machines 1A, 1B and 1C.

The ascertainment unit 202 of the present embodiment has a plurality of comparative relationship calculation units 204, and one overall determination unit 205. The comparative relationship calculation units 204 are provided so as to correspond to the three injection molding machines 1A, 1B and 1C on a one-by-one basis. Each comparative relationship calculation unit 204 has the same function as the comparative relationship calculation unit 104 of the above-described management system for injection molding machine. Specifically, the plurality of physical quantity measurement units 201 provided at the injection molding machines 1A, 1B and 1C input the plurality of physical quantity data, and the comparative relationship calculation units 204 calculate, from the inputted physical quantity data, comparative relationships (hereinafter, referred to as the first comparative relationships) each representing a relational state of the physical quantity data between the movable parts of the associated one of the injection molding machines 1A, 1B and 1C. Like the “comparative relationship” described above, the “first comparative relationship” refers to a relationship in terms of magnitude, such as large or small and high or low, between the physical quantity data, and represents a balance between the states (temperature, strain, vibration, etc.) of the plurality of movable parts subjected to the measurement of the physical quantity.

The comparative relationship calculation units 204 output the respective data of the calculated first comparative relationships to the overall determination unit 205 shared by the comparative relationship calculation units 204. Further, the comparative relationship calculation units 204 of the present embodiment are configured to output, to the overall determination unit 205, the respective physical quantity data itself inputted from the physical quantity measurement units 201, in addition to the data of the first comparative relationships.

The overall determination unit 205 comprehensively determines, based on the data of the first comparative relationships and the physical quantity data that have been inputted from the comparative relationship calculation units 204, whether an abnormal state is present in or absent from the injection molding machines 1A, 1B and 1C. The overall determination unit 205 includes a first determination unit 206, a second determination unit 207 and an update unit 208.

The first determination unit 206 has a function of: comparing the data of each of the first comparative relationships inputted from the three comparative relationship calculation units 204 with data of a reference comparative relationship (hereinafter, referred to as the first reference comparative relationship) that is preset in the first determination unit 206; and determining whether each of the first comparative relationships of the injection molding machines 1A, 1B and 1C deviates from the first reference comparative relationship. Like the above-described “reference comparative relationship”, the “first reference comparative relationship” represents an ideal comparative relationship of the physical quantity data between the plurality of movable parts subjected to the measurement of the physical quantity, the ideal comparative relationship being observed when the movable parts are in a normal state. Therefore, the determination by this first function of the first determination unit 206 is performed for each of the injection molding machines 1A, 1B and 1C, in the same manner as in the above-described management system for injection molding machine. This function of the first determination unit 206 is defined as a first function of the ascertainment unit 202.

Further, when determining that any of the first comparative relationships deviates from the first reference comparative relationship as a result of the comparison between each of the first comparative relationships of the injection molding machines 1A, 1B and 1C with the first reference comparative relationship, the first determination unit 206 carries out a function of comparing the plurality of data of the first comparative relationships of the injection molding machines 1A, 1B and 1C with each other so as to determine whether an unbalanced comparative relationship exists between the first comparative relationships. This function of the first determination unit 206 is defined as a second function of the ascertainment unit 202.

For example, supposing that temperatures as the physical quantity data are measured at the central bushes 367 and the front bushes 368 of the mold clamping mechanism unit 3 of each of the injection molding machines 1A, 1B and 1C, the first comparative relationships are calculated from the measured temperatures, and the temperatures and the first comparative relationships are in the relational state shown in Table 1 below. In this case, a separate observation of each of the injection molding machines 1A, 1B and 1C shows that each of the first comparative relationships is in an unbalanced state as compared with the normal state, and deviates from a normal range (from 2° C. to 8° C.) of comparative relationship set with respect to the first reference comparative relationship. However, a comparison between the data of the first comparative relationships shows that the values exhibited by the three injection molding machines 1A, 1B and 1C are almost the same, and that the first comparative relationships of the injection molding machines 1A, 1B and 1C are all in the same or similar imbalance (i.e., the balance between the first comparative relationships is not disrupted). In this case, it is presumed that the deviation from the normal range has been caused not by a change in a state specific to the injection molding machines 1A, 1B and 1C, but by, for example, a change due to a fault in a temperature control system that uses a temperature control medium and is common to the injection molding machines 1A, 1B and 1C.

TABLE 1

| | INJECTION | INJECTION | INJECTION |
|---|---|---|---|
| | MOLDING | MOLDING | MOLDING |
| | MACHINE | MACHINE | MACHINE |
| | 1A | 1B | 1C |
| CENTRAL BUSH | 40° C. | 40° C. | 40° C. |
| FRONT BUSH | 50° C. | 50° C. | 51° C. |
| FIRST COMPARATIVE | 10° C. | 10° C. | 11° C. |
| RELATIONSHIP | | | |
| (FRONT BUSH − | | | |
| CENTRAL BUSH) | | | |
| FIRST REFERENCE | 5° C. | 5° C. | 5° C. |
| COMPARATIVE | | | |
| RELATIONSHIP | | | |
| THRESHOLD | ±3° C. | ±3° C. | ±3° C. |
| NORMAL RANGE OF | 2~8° C. | 2~8° C. | 2~8° C. |
| COMPARATIVE | | | |
| RELATIONSHIP | | | |

A determination on whether the balance between the first comparative relationships is disrupted can be made in the following manner: comparative relationships (hereinafter, referred to as the second comparative relationships) are calculated, the second comparative relationships each representing a relational state of the first comparative relationships between the plurality of injection molding machines 1A, 1B and 1C; and then, the calculated second comparative relationships are compared with a reference comparative relationship (hereinafter, referred to as the second reference comparative relationship) that is preset in the first determination unit 206. The “second comparative relationship” refers to a relationship in terms of magnitude, such as large or small and high or low, between the data of the first comparative relationships, and represents a balance between the first comparative relationships. The “second reference comparative relationship” represents an ideal comparative relationship of the data of the first comparative relationships between the injection molding machines 1A, 1B and 1C, the ideal comparative relationship being observed when the injection molding machines 1A, 1B and 1C are in a normal state. Therefore, if the second comparative relationships deviate from the second reference comparative relationship, it is determined that the balance between the first comparative relationships has been disrupted (an abnormal state). If the second comparative relationships do not deviate from the second reference comparative relationship, it is determined that the balance between the first comparative relationships has not been disrupted (non-abnormal state).

As a result, in a situation where the second comparative relationships do not deviate from the second reference comparative relationship, and thus, the first comparative relationships are in a relational state in which a certain balance is kept between the first comparative relationships, it can be determined that the injection molding machines 1A, 1B and 1C themselves are not in an abnormal state, making it possible to simplify or omit work by the operator, such as checking and greasing.

The first determination unit 206 can make the determination on whether the second comparative relationship deviates from the second reference comparative relationship by, for example, determining whether a difference between the data of the second comparative relationship and the data of the second reference comparative relationship is within a predetermined threshold range. Specifically, a situation where the calculated difference between the second comparative relationship and the second reference comparative relationship is “0” (a situation where the temperatures are equal to each other) is defined as a reference, and a range is set while a predetermined threshold such as a measurement error of, e.g., “±5” (±5° C.) is taken into account. The determination on whether the second comparative relationship deviates from the second reference comparative relationship can be made by determining whether the difference therebetween is within the range.

The second determination unit 207 has a function of: calculating, from the physical quantity data respectively inputted from the comparative relationship calculation units 204, comparative relationships (hereinafter referred to as the third comparative relationships) each representing a relational state of the physical quantity data between the same movable parts respectively included in the injection molding machines 1A, 1B and 1C; comparing the third comparative relationships with a reference comparative relationship (hereinafter referred to as the third reference comparative relationship) that is preset in the second determination unit 207; and determining whether the third comparative relationships deviate from the third reference comparative relationship. The “third comparative relationship” refers to a relationship in terms of magnitude, such as large or small and high or low, between the physical quantity data of the same movable parts respectively included in the injection molding machines 1A, 1B and 1C, and represents a balance between the physical quantity data. The “third reference comparative relationship” represents an ideal comparative relationship of the physical quantity data between the same movable parts of the injection molding machines 1A, 1B and 1C, the ideal comparative relationship being observed when the injection molding machines 1A, 1B and 1C are in a normal state. This function of the second determination unit 207 is defined as a third function of the ascertainment unit 202.

The overall determination unit 205 causes the second determination unit 207 to compare the third comparative relationships of the three injection molding machines 1A, 1B and 1C with the third reference comparative relationship, thereby making a determination on an abnormal state of a movable part of a specific one of the injection molding machines, the abnormal state being impossible to detect through monitoring conducted by the first determination unit 206 for each of the injection molding machines 1A, 1B and 1C.

For example, supposing that temperatures as the physical quantity data are measured at the central bush 367 and the front bush 368 that are movable parts of the mold clamping mechanism unit 3 of each of the injection molding machines 1A, 1B and 1C, the first comparative relationships are calculated from the measured temperatures, and the temperatures and the first comparative relationships are in the relational state shown in Table 2 below. In this case, a comparison made by the first determination unit 206 between the first reference comparative relationship and the first comparative relationship of each of the injection molding machines 1A, 1B and 1C shows that all of the first comparative relationships are within a normal range (from 2° C. to 8° C.), whereby the injection molding machines 1A, 1B and 1C are determined to be in a normal state. However, a comparison of the temperatures of the central bushes 367 between the injection molding machines 1A, 1B and 1C and a comparison of the temperatures of the front bushes 368 between the injection molding machines 1A, 1B and 1C demonstrate that while the respective temperatures of the injection molding machines 1A and 1C are almost equal to each other, the temperatures of the injection molding machine 1B are high and disrupt the balance. In this case, it is presumed that some abnormality, such as abnormal wear, has occurred in the central bush 367 and the front bush 368 of the injection molding machine 1B.

TABLE 2

| | INJECTION | INJECTION | INJECTION |
|---|---|---|---|
| | MOLDING | MOLDING | MOLDING |
| | MACHINE | MACHINE | MACHINE |
| | 1A | 1B | 1C |
| CENTRAL BUSH | 40° C. | 50° C. | 40° C. |
| FRONT BUSH | 45° C. | 58° C. | 46° C. |
| FIRST COMPARATIVE | 5° C. | 8° C. | 6° C. |
| RELATIONSHIP | | | |
| (FRONT BUSH − | | | |
| CENTRAL BUSH) | | | |
| FIRST REFERENCE | 5° C. | 5° C. | 5° C. |
| COMPARATIVE | | | |
| RELATIONSHIP | | | |
| THRESHOLD | ±3° C. | ±3° C. | ±3° C. |
| NORMAL RANGE OF | 2~8° C. | 2~8° C. | 2~8° C. |
| COMPARATIVE | | | |
| RELATIONSHIP | | | |

Accordingly, the second determination unit 207 calculates, as the third reference comparative relationships, a difference between the values of the central bushes 367 and a difference between the values of the front bushes 368 of the injection molding machines 1A, 1B and 1C, thereby making it possible to ascertain a relational state in which the central bush 367 and the front bush 368 of the injection molding machine 1B have higher temperature than the central bushes 367 and the front bushes 368 of the other injection molding machines 1A and 1B.

The second determination unit 207 can make the determination on whether the third comparative relationship deviates from the third reference comparative relationship by, for example, determining whether a difference between the data of the third comparative relationship and the data of the third reference comparative relationship is within a predetermined threshold range. Specifically, a situation where the calculated difference between the third comparative relationship and the third reference comparative relationship is “0” (a situation where the temperatures are equal to each other) is defined as a reference, and a range is set while a predetermined threshold such as a measurement error of, e.g., “±5” (±5° C.) is taken into account. The determination on whether the third comparative relationship deviates from the third reference comparative relationship can be made by determining whether the difference therebetween is within the range.

The above determination process by the first determination unit 206 and the above determination process by the second determination unit 207 may take place sequentially or parallelly in the ascertainment unit 202. If the presence of an abnormal movable part is determined by the first determination unit 206 or the second determination unit 207, the information about the injection molding machine having the abnormal movable part and the information about the abnormal movable part are outputted to the alarm unit 203.

Like the alarm unit 103 of the management system for injection molding machine described above, the alarm unit 203 alerts the operator to the abnormal state of the injection molding machine 1A, 1B or 1C when the abnormal state is ascertained by the ascertainment unit 202. Further, at the same time, information about the abnormal movable part outputted from the ascertainment unit 202 can also be provided to the operator.

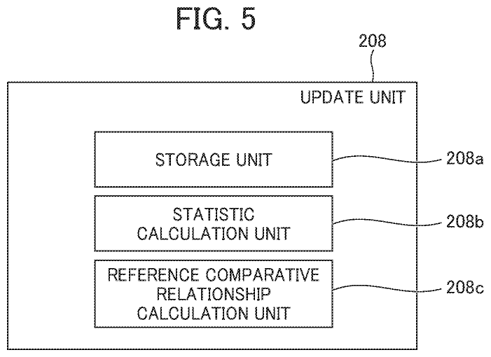

Next, the update unit 208 of the overall determination unit 205 in the ascertainment unit 202 will be described. FIG. 5 is a block diagram showing a configuration of the update unit 208. The ascertainment unit 202 of the centralized management system of the present embodiment includes the update unit 208, and accordingly, has a function of calculating the reference comparative relationship to be compared with the comparative relationship, and of updating the calculated reference comparative relationship to a new reference comparative relationship, as will be described below. This function is defined as a fourth function of the ascertainment unit 202.

Specifically, as shown in FIG. 5, the update unit 208 includes a storage unit 208a, a statistic calculation unit 208b and a reference comparative relationship calculation unit 208c.

The storage unit 208a temporarily stores the physical quantity data inputted to the overall determination unit 205 from the comparative relationship calculation units 204. Since the acquisition of the physical quantity data is repeatedly performed in a predetermined control cycle, the storage unit 208a of the update unit 208 receives a plurality of physical quantity data of the same movable part and stores the plurality of physical quantity data for a predetermined period.

The statistic calculation unit 208b calculates statistics of the physical quantity data based on the plurality of physical quantity data that have been inputted to, and stored in, the storage unit 208a for the predetermined period. The statistics can be calculated, for example, from a standard deviation, a maximum value, a minimum value, an average value, etc. of the plurality of physical quantity data.

The reference comparative relationship calculation unit 208c calculates a comparative relationship between movable parts for each of the injection molding machines 1A, 1B and 1C (hereinafter, referred to as the updating reference comparative relationship), based on the statistics of the physical quantity data calculated by the statistic calculation unit 208b. The data of the updating reference comparative relationship calculated by the reference comparative relationship calculation unit 208c is used as data of a new first reference comparative relationship to be compared with the first comparative relationships by the first determination unit 206. Specifically, after the updating reference comparative relationship is calculated by the reference comparative relationship calculation unit 208c, the update unit 208 updates the data of the first reference comparative relationship preset in the first determination unit 206, to the data of the updating reference comparative relationship. Thereafter, the first determination unit 206 compares the new first reference comparative relationship that has been updated, with each comparative relationship.

The statistics calculated by the statistic calculation unit 208b are based on the plurality of physical quantity data of the same movable parts respectively included in the injection molding machines 1A, 1B and 1C, the plurality of physical quantity data having been inputted for a certain period of time. Thus, the statistics are physical quantity data in which measurement errors, individual differences, etc. are taken account of. Therefore, use of the updating reference comparative relationship calculated by the reference comparative relationship calculation unit 208c as a new reference comparative relationship makes it possible to reduce errors in ascertainment of the abnormal state, which errors can be caused by the measurement errors, the individual differences between the machines, etc., thereby enabling more accurate ascertainment of the abnormal state.

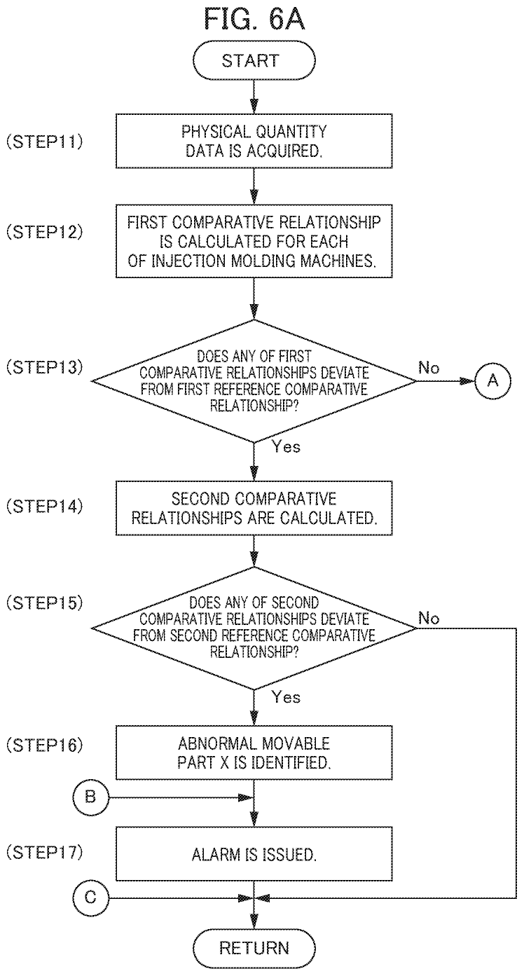

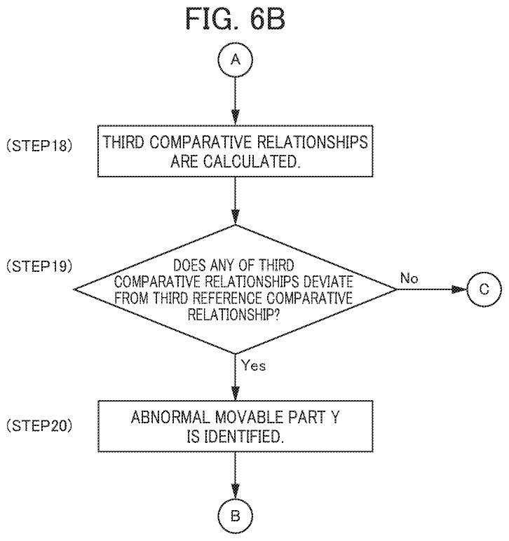

Next, specific control for ascertaining an abnormal state, performed by the centralized management system for injection molding machines of the present embodiment will be described with reference to FIGS. 6A and 6B. FIGS. 6A and 6B are flowcharts showing an example of control performed by the centralized management system injection molding machines shown in FIG. 4. In this example, the first determination unit 206 and the second determination unit 207 carry out the respective processing in this order. However, the processing of the second determination unit 207 may be followed by the processing of the first determination unit 206. Alternatively, the first determination unit 206 and the second determination unit 207 may carry out the respective processing in parallel.

Also in the present embodiment, a plurality of physical quantity data of the injection molding machines 1A, 1B and 1C are acquired repeatedly in a predetermined control cycle during operation of the injection molding machines 1A, 1B and 1C. When the predetermined control cycle starts, the centralized management unit 200 acquires the plurality of physical quantity data from the plurality of physical quantity measurement units 201 respectively provided at the plurality of movable parts of the injection molding machines 1A, 1B and 1C, and then, inputs the acquired data to the respective comparative relationship calculation units 204 of the ascertainment unit 202 (STEP 11). The plurality of physical quantity data acquired in STEP 11 is also inputted from the comparative relationship calculation units 204 to the overall determination unit 205.

Next, the comparative relationship calculation units 204 of the ascertainment unit 202 calculate, from the acquired physical quantity data, the first comparative relationships respectively associated with the injection molding machines 1A, 1B and 1C (STEP 12). Data of each of the calculated first comparative relationships is outputted to the overall determination unit 205.

In the overall determination unit 205, the first determination unit 206 compares the data of each of the first comparative relationships, which are respectively associated with the injection molding machines 1A, 1B and 1C and have been calculated by the respective comparative relationship calculation units 204, with the data of the first reference comparative relationship preset in the first determination unit 206, and then, determines whether any of the first comparative relationships deviates from the first reference comparative relationship (STEP 13).

If it is determined that any of the first comparative relationships deviates from the first reference comparative relationship (if the answer is Yes in STEP 13) as a result of the comparison performed in STEP 13, the first determination unit 206 then calculates the second comparative relationships, which are relationships between the plurality of first comparative relationships, based on the data of the plurality of first comparative relationships respectively associated with the injection molding machines 1A, 1B and 1C (STEP 14).

Next, the first determination unit 206 compares the data of each of the calculated second comparative relationships with the data of the second reference comparative relationship preset in the first determination unit 206, and then, determines whether any of the second comparative relationships deviates from the second reference comparative relationship (STEP 15).

If it is determined here that none of the second comparative relationships deviates from the second reference comparative relationship (if the answer is No in STEP 15), the processing returns. On the other hand, if it is determined that any of the second comparative relationships deviates from the second reference comparative relationship (if the answer is Yes in STEP 15), the first determination unit 206 identifies a movable part causing disruption of balance (hereinafter, referred to as the abnormal movable part X) among the movable parts of the injection molding machines 1A, 1B and 1C, and the injection molding machine including the abnormal movable part X, based on the data of the second comparative relationships (STEP 16).

When the abnormal movable part X and the injection molding machine including the abnormal movable part X are identified in STEP 16, the ascertainment unit 202 outputs a signal indicative of information about the abnormal movable part X and the injection molding machine to the alarm unit 203 (STEP 17). In response to this, the alarm unit 203 issues an alarm indicating that the injection molding machine 1A, 1B or 1C has the abnormal movable part X so as to alert the operator to the abnormal state of the injection molding machine 1A, 1B or 1C.

In response to the alarm issued by the alarm unit 203, the operator can check the state of the abnormal movable part X of the injection molding machine 1A, 1B or 1C. If the operator determines that the state of the abnormal movable part X has been caused by simple lack of grease, the operator greases the abnormal movable part X.

After the issuance of the alarm in STEP 17, the process returns. However, if the operator determines that the abnormal movable part X does not lack grease, but is in an abnormal state such as abnormal wear, the operator stops the operation of the injection molding machine 1A, 1B or 1C, and carries out part replacement or the like. Alternatively, the centralized management unit 200 may automatically stop the operation of the injection molding machine 1A, 1B or 1C that includes the abnormal movable part X, at the same time as the issuance of the alarm in STEP 17.

On the other hand, if it is determined that none of the first comparative relationships deviates from the first reference comparative relationship (if the answer is No in STEP 13) as the result of the comparison performed in STEP 13, the second determination unit 207 then calculates the third comparative relationships between the same movable parts of the injection molding machines 1A, 1B and 1C, based on the respective physical quantity data (STEP 18).

Subsequently, the second determination unit 207 compares the data of each of the calculated third comparative relationships with the data of the third reference comparative relationship preset in the second determination unit 207, and then determines whether any of the third comparative relationships deviates from the third reference comparative relationship (STEP 19).

If it is determined here that none of the third comparative relationships deviates from the third reference comparative relationship (if the answer if No in STEP 19), the process returns. On the other hand, if it is determined that any of the third comparative relationships deviates from the third reference comparative relationship (if the answer is Yes in STEP 19), the second determination unit 207 identifies a movable part causing disruption of balance (hereinafter, referred to as the abnormal movable part Y) among the movable parts of the injection molding machines 1A, 1B or 1C, and the injection molding machine including the abnormal movable part Y (STEP 20).

When the abnormal movable part Y and the injection molding machine including the abnormal movable part Y are identified in STEP 20, the ascertainment unit 202 outputs a signal indicative of information about the abnormal movable part Y and the injection molding machine to the alarm unit 203 (STEP 17). In STEP 17, the alarm unit 203 issues an alarm based on the signal outputted from the ascertainment unit 202, in the same manner as described above.

In the present embodiment, since the plurality of injection molding machines 1A, 1B and 1C are thus managed in a centralized manner, the first function of the ascertainment unit 202 enables accurate ascertainment of an abnormal state of the respective movable parts for each of the injection molding machines 1A, 1B and 1C, without being affected by a change in the external environment, a change in the molding conditions, etc.

Further, even in a case where the comparative relationships (first comparative relationships) calculated from the physical quantity data of the injection molding machines 1A, 1B and 1C are in a state unbalanced as compared with the comparative relationships in a normal state, when the data of all the comparative relationships of the injection molding machines 1A, 1B and 1C are in the same or similar unbalanced state, the second function of the ascertainment unit 202 enables a determination that the imbalance has been caused by not a change in a state specific to the injection molding machines 1A, 1B and 1C, but a change in room temperature or a change due to a fault in a temperature control system (a determination that no abnormal state has been occurred), thereby eliminating unnecessary work by the operator, such as checking or greasing.

Furthermore, even if the comparative relationship calculated from the physical quantity data of each of the injection molding machines 1A, 1B and 1C is in a normal state, the ascertainment unit 202 carries out the third function of comparing the physical quantity data between the injection molding machines 1A, 1B and 1C, thereby enabling further accurate ascertainment of an abnormal state of a specific one of the injection molding machines.

In each of the above-described embodiments of the management system for injection molding machine and the centralized management system for injection molding machines, the physical quantity data obtained by the physical quantity measurement units 101 or 201 may be any one of temperature data, vibration data and strain data. Alternatively, each of the embodiments may be modified such that at least two different types of physical quantity data selected from the temperature data, the vibration data and the strain data are measured, a comparative relationship is calculated for each of the at least two types of the data, and each of the calculated comparative relationships is compared with a reference comparative relationship that is set for each of the comparative relationships.

Further, in each of the above-described embodiments of the management system for injection molding machine and the centralized management system for injection molding machines, the physical quantity measurement units 101 or 201 are not limited to those provided at a plurality of movable parts of one of the mold unit 2, the mold clamping mechanism unit 3 and the injection mechanism unit 4 of the injection molding machine 1 or the injection molding machines 1A, 1B and 1C. The physical quantity measurement units 101 or 201 may be provided at the plurality of movable parts of at least two of the mold unit 2, the mold clamping mechanism unit 3 and the injection mechanism unit 4.

### EXPLANATION OF REFERENCE NUMERALS

1, 1A, 1B, 1C: Injection Molding Machine
2: Mold Unit
3: Mold Clamping Mechanism Unit
4: Injection Mechanism Unit
100: Management Unit
101: Physical Quantity Measurement Unit
102: Ascertainment Unit
103: Alarm Unit
104: Comparative Relationship Calculation Unit
105: Determination Unit
200: Centralized Management Unit
201: Physical Quantity Measurement Unit
202: Ascertainment Unit
203: Alarm Unit
204: Comparative Relationship Calculation Unit
205: Overall Determination Unit
206: First Determination Unit
207: Second Determination Unit
208: Update Unit
208a: Storage Unit
208b: Statistics Calculation Unit
208c: Reference Comparative Relationship Calculation Unit

What is claimed is:

1. A management system for injection molding machine, the management system including an injection molding machine and a management unit for managing the injection molding machine, wherein
the management unit comprises:
a plurality of physical quantity measurement units configured to be provided at a plurality of movable parts included in the injection molding machine;
an ascertainment unit configured to calculate, based on a plurality of physical quantity data respectively measured by the plurality of physical quantity measurement units, a comparative relationship representing a relational state of the plurality of physical quantity data between the plurality of the movable parts, and to ascertain whether the comparative relationship deviates from a preset reference comparative relationship; and
an alarm unit configured to issue an alarm when the ascertainment unit ascertains that the comparative relationship deviates from the reference comparative relationship.

2. The management system according to claim 1, wherein
the plurality of physical quantity data is at least one of temperature data, vibration data or strain data.

3. The management system according to claim 1, wherein
when ascertaining that the comparative relationship deviates from the reference comparative relationship, the ascertainment unit identifies an abnormal movable part among the plurality of movable parts, and
the alarm unit alerts an operator to the abnormal movable part of the injection molding machine, based on information about the abnormal movable part identified by the ascertainment unit.

4. The management system according to claim 1, wherein
the injection molding machine has at least a mold unit, a mold clamping mechanism unit and an injection mechanism unit, and
the plurality of physical quantity measurement units are provided at a plurality of movable parts included in at least one of the mold unit, the mold clamping mechanism unit or the injection mechanism unit.

5. A centralized management system for injection molding machines, the centralized management system including a plurality of injection molding machines and a centralized management unit for managing the plurality of injection molding machines in a centralized manner, wherein
the centralized management unit comprises:
a plurality of physical quantity measurement units configured to be provided at a plurality of movable parts included in each of the plurality of injection molding machines;
an ascertainment unit configured to ascertain whether any of the plurality of injection molding machines is in an abnormal state, based on a plurality of physical quantity data respectively measured by the plurality of physical quantity measurement units; and
an alarm unit configured to issue an alarm,
the ascertainment unit has:
a first function of calculating a plurality of first comparative relationships each representing a relational state of the plurality of physical quantity data between the movable parts included in an associated one of the injection molding machines, based on the plurality of physical quantity data respectively measured by the plurality of physical quantity measurement units, and of ascertaining whether there is a deviation of any of the first comparative relationships from a preset first reference comparative relationship; and
a second function of calculating a plurality of second comparative relationships each representing a relational state between the plurality of first comparative relationships of the plurality of injection molding machines, and of ascertaining whether there is a deviation of any of the second comparative relationships from a preset second reference comparative relationship, the second function being carried out when presence of the deviation is ascertained by the first function, and
the alarm unit issues an alarm when presence of the deviation is ascertained by the second function.

6. The centralized management system according to claim 5, wherein
when ascertaining the presence of the deviation by the second function, the ascertainment unit identifies an abnormal movable part of among the plurality of movable parts of the plurality of injection molding machines, and
the alarm unit alerts an operator to the abnormal movable part of the plurality of injection molding machines, based on information about the abnormal movable part identified by the ascertainment unit when the presence of the deviation is ascertained by the second function.

7. The centralized management system according to claim 5, wherein
the ascertainment unit further has a third function of calculating a plurality of third comparative relationships each representing a relational state of the plurality of physical quantity data between same ones of the plurality of movable parts of the plurality of injection molding machines, and of ascertaining whether there is a deviation of any of the plurality of third comparative relationships from a preset third reference comparative relationship, the third function being carried out when absence of the deviation is ascertained by the first function, and
the alarm unit issues an alarm when presence of the deviation is ascertained by the third function.

8. The centralized management system according to claim 7, wherein
when ascertaining the presence of the deviation by the third function, the ascertainment unit identifies an abnormal movable part of among the plurality of movable parts of the plurality injection molding machines, and
the alarm unit alerts the operator to the abnormal movable part of the plurality of injection molding machines, based on information about the abnormal movable part identified by the ascertainment unit when the presence of the deviation is ascertained by the third function.

9. The centralized management system according to claim 5, wherein
the ascertainment unit further has a fourth function of calculating a statistic of the plurality of physical quantity data respectively measured by the plurality of physical quantity measurement units, of calculating a updating reference comparative relationship based on the statistic, and of updating the preset first reference comparative relationship to the updating reference comparative relationship.

10. The centralized management system according to claim 5, wherein
the plurality of physical quantity data is at least one of temperature data, vibration data or strain data.

11. The centralized management system according to claim 5, wherein
each of the plurality of injection molding machines has at least a mold unit, a mold clamping mechanism unit and an injection mechanism unit, and
the plurality of physical quantity measurement units are provided at a plurality of movable parts included in at least one of the mold unit, the mold clamping mechanism unit or the injection mechanism unit.
